(19) United States
(12) Patent Application Publication
(10) Pub. No.: US 2025/0284289 A1
(43) Pub. Date: Sep. 11, 2025

(54) Method for Controlling a Robot Device

(71) Applicant: Robert Bosch GmbH, Stuttgart (DE)

(72) Inventors: Florian Drews, Renningen (DE); Florian Faion, Staufen (DE); Lars Rosenbaum, Lahntal (DE); Koba Natroshvili, Waldbronn (DE); Claudius Glaeser, Ditzingen (DE)

(21) Appl. No.: 18/862,672

(22) PCT Filed: Apr. 26, 2023
(86) PCT No.: PCT/EP2023/060893

§ 371 Date: Nov. 4, 2024

(30) Foreign Application Priority Data
May 16, 2022 (DE) 10 2022 204 770.2

(51) Int. Cl. G05D 1/633; G05B 13/02

(52) U.S. Cl. CPC G05D 1/633; G05B 13/027

(57) ABSTRACT

A method for controlling a robot device includes (i) receiving, from each sensor of a plurality of sensors, a respective sensor data set from the sensor, (ii) determining, for each object of a set of objects containing at least one object, for each of a plurality of different combinations of the sensor data sets, a position prediction for the object by way of sensor data fusion of the sensor data sets according to the combination of the sensor data sets, (iii) determining, for each object of the set of objects, for each pair of a plurality of pairs of combinations, a distance between the position predictions determined for the object according to the combinations of the pair, (iv) feeding the determined distances to a neural network trained to determine confidence information for the position predictions from distances between position predictions for the pairs of combinations, and (v) controlling the robot device using one or a plurality of the position predictions taking into account the confidence information.

### PRIOR ART

The present disclosure relates to methods for controlling a robot device.

In various applications, good results can be achieved when sensor (data) fusion is performed from different sensors and a robot device is controlled using the results of the sensor data fusion. For example, in autonomous driving, sensor data from optical cameras, radar sensors, lidar sensors and others can be combined to increase the reliability of object detection.

There are approaches to sensor fusion based on machine learning and approaches based on the Dempster-Shafer theory. Depending on the architecture used for sensor fusion, each sensor can contribute differently to the final result based on the proportion of data it contributes to the overall data, the type of sensor, time of day, weather, object characteristics, etc.

With sensor fusion, however, the deterioration in the measurement quality of even a single sensor can have a major impact on the final result.

To address this problem, DE 10 2018 222526 A1, hereinafter referred to as reference 1, describes a hybrid (or multi-path) architecture. Data from different sensors is merged in different ways. In this way, redundant detections of the same object are obtained. If a single sensor is faulty, one or a plurality of fault-free modalities (i.e. ways of combining sensor data from a plurality of sensors, in particular including the selection of which sensors to combine data from) can still be obtained in this way. Different modalities use sensor data from the different sensors with different proportions (e.g. with three sensors 70%-30%-0% or 70%-15%-15% etc.) and the dependencies of the result on the sensor data can be different.

With the multi-path architecture, poor measurement quality of one sensor can affect a plurality of modalities. Therefore, approaches are desirable that make it possible to determine which modalities can be trusted in comparison to others, i.e. approaches to estimate the trustworthiness of the modalities so that the results from these modalities can then be used for reliable control.

### DISCLOSURE OF THE INVENTION

According to various embodiments, a method is proposed for controlling a robot device, including receiving, from each sensor of a plurality of sensors, a respective sensor data set from the sensor; determining, for each object of a set of objects containing at least one object, for each of a plurality of different combinations of the sensor data sets, a position prediction for the object by means of sensor data fusion of the sensor data sets according to the combination of the sensor data sets; determining, for each object of the set of objects, for each pair of a plurality of pairs of combinations, a distance between the position predictions determined for the object according to the combinations of the pair; feeding the determined distances to a neural network trained to determine confidence information for the position predictions from distances between position predictions for the pairs of combinations; and controlling the robot device using one or a plurality of the position predictions taking into account the confidence information.

The method described above makes it possible to avoid or at least minimize the influence of the poor measurement quality on the overall result of the sensor (data) fusion in the event of poor measurement quality of a sensor that has an influence on a plurality of modalities. The neural network learns the dependencies between the modalities and is therefore able to recognize a failure or a decrease in the measurement quality of a sensor and express it in the confidence information.

The confidence information can be given to an object tracking device, for example. This can weight the results for the various modalities according to their confidence levels when combining the results, for example.

Various exemplary embodiments are specified in the following.

Exemplary embodiment 1 is a method used for controlling a robot device, as described above.

Exemplary embodiment 2 is a method according to exemplary embodiment 1, wherein the set of objects contains a plurality of objects.

This means that the confidence information is determined jointly for a plurality of objects, which means that the confidence information can be performed independently of tracking individual objects.

Exemplary embodiment 3 is a method according to exemplary embodiment 2, wherein the set of objects comprises objects in a predetermined sub-area of the surroundings of the robot device detected by the sensors.

The confidence information is therefore determined jointly for objects that are located in a sub-area of the surroundings of the robot devices covered by the sensors. This means that, on the one hand, no individual tracking of the objects within the areas is required to determine the confidence information, as it is determined jointly for the objects, and on the other hand, a high accuracy of the determination (i.e. estimation) of the confidence information can be achieved because the conditions for the sensors fluctuate less strongly in sub-areas of the surroundings than over the entire surroundings. For sufficiently small sub-areas, it is therefore reasonable to assume that each sensor has a similar accuracy for all objects in a sub-area.

Exemplary embodiment 4 is a method according to one of exemplary embodiments 1 to 3, wherein the neural network receives, as input for each pair of the plurality of pairs of the combinations, the distance between the position predictions determined for the object according to the combinations of the pair and one or a plurality of results of object detection using the sensor data sets, and is trained to determine the confidence information from the input.

The one or a plurality of results of the object detection are, for example, position, dimension, class membership (e.g. as a soft value) and orientation of the objects (and at least a part thereof). These inputs increase the accuracy of the estimation of the confidence information.

Exemplary embodiment 5 is a method according to one of exemplary embodiments 1 to 4, wherein the set of objects contains a plurality of objects and the neural network is set up such that it is invariant to a permutation of the objects.

This ensures that the confidence information is determined in such a way that it is independent of how the objects are numbered.

Exemplary embodiment 6 is a method according to exemplary embodiment 5, wherein the neural network comprises a pooling of processing results of different objects.

In this way, invariance to permutations of the objects can be achieved in a simple way.

Exemplary embodiment 7 is a method according to one of exemplary embodiments 1 to 6, wherein the neural network is set up to process input data for a variable number of objects, which input data contains the distances between position predictions for the pairs of combinations for each of the objects.

This allows the neural network to be trained for and used for different numbers of objects, i.e. it can be used regardless of how many objects are detected by the sensors. This can be achieved, for example, by storing the input data per object in an input data element (e.g. a vector) and the neural network is set up to perform a convolution over the input data elements, since a convolution can be applied to a variable number of such input data elements. Following convolution, for example, the convolution results can be pooled across the objects so that a processing result is generated whose dimension is independent of the number of objects.

Exemplary embodiment 8 is a method according to one of exemplary embodiments 1 to 7, comprising training the neural network by supervised learning using training data elements, wherein each training data element comprises a training input element having, for each pair of the combinations, a distance between position predictions for one or a plurality of objects of known position and a training target output element, wherein the training target output element comprises, for each of the combinations, a training target output for the confidence information given by, for each of the one or a plurality of objects, a distance between the position prediction for the object according to the combination and the known position of the object.

For example, the distances can be averaged over the objects to determine the training target output for the combination or confidence information (i.e. a confidence value) can be determined for each object from the respective distance and these confidence values can be averaged over the objects.

Exemplary embodiment 9 is a robot control device which is set up to perform a method according to one of exemplary embodiments 1 to 8.

Exemplary embodiment 10 is a computer program comprising instructions that, when executed by a processor, cause the processor to carry out a method according to one of exemplary embodiments 1 to 8.

Exemplary embodiment 11 is a computer-readable medium that stores instructions which, when executed by a processor, cause the processor to perform a method according to one of exemplary embodiments 1 to 8.

In the drawings, similar reference signs generally refer to the same parts throughout the different views. The drawings are not necessarily to scale, wherein emphasis is instead generally placed on representing the principles of the invention. In the following description, various aspects are described with reference to the following drawings.

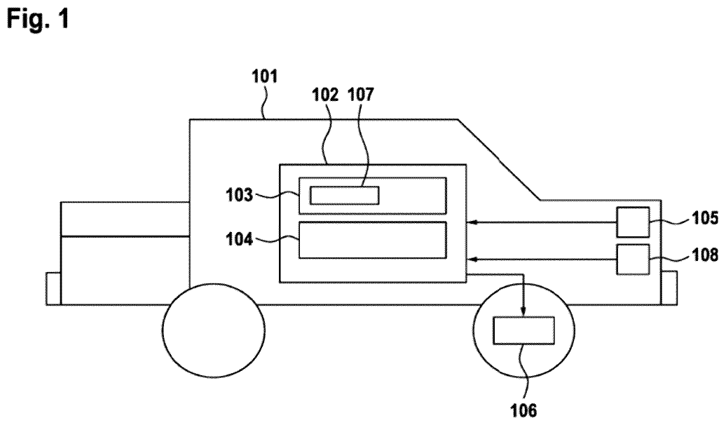

FIG. 1 shows a vehicle.

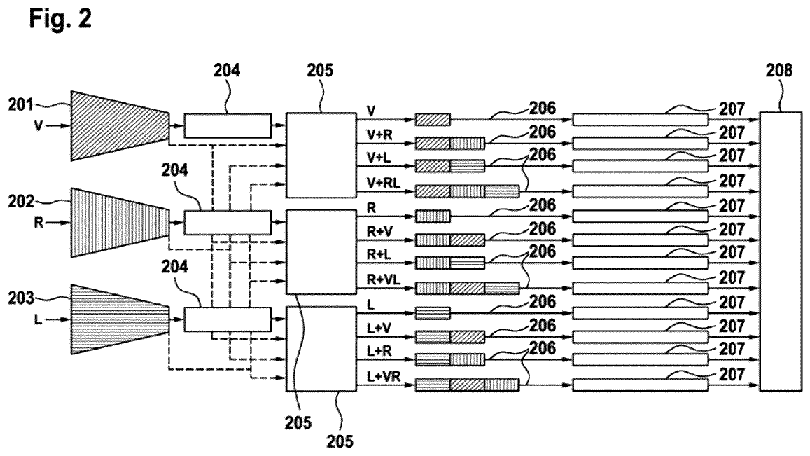

FIG. 2 shows an example of a multi-path architecture for multimodal sensor fusion.

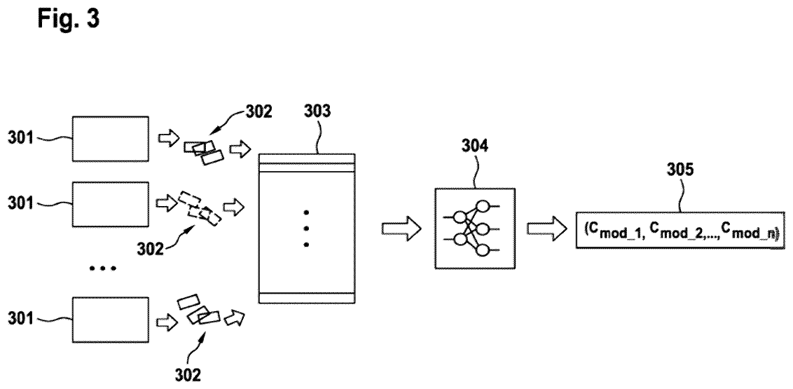

FIG. 3 illustrates the determination of confidence information for modalities according to one embodiment.

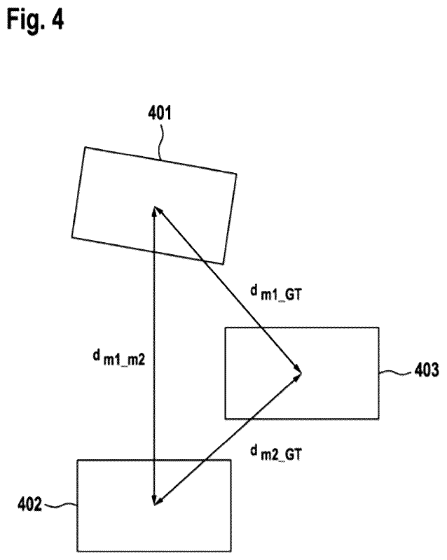

FIG. 4 illustrates the distances between position estimations of two modalities and the distances to the true object position for the ground truth.

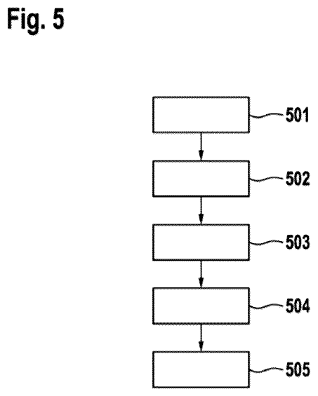

FIG. 5 shows a flowchart illustrating a method for controlling a robot device according to one embodiment.

The following detailed description relates to the accompanying drawings, which, for clarification, show specific details and aspects of this disclosure in which the invention can be implemented. Other aspects can be used, and structural, logical, and electrical changes can be performed without departing from the scope of protection of the invention. The various aspects of this disclosure are not necessarily mutually exclusive since some aspects of this disclosure can be combined with one or a plurality of other aspects of this disclosure to form new aspects.

Different examples will be described in more detail in the following.

FIG. 1 shows a vehicle 101.

The vehicle 101, for example a car or truck, is equipped with a vehicle control device 102.

The vehicle control device 102 comprises data processing components, e.g., a processor (e.g., a CPU (central processing unit)) 103 and a memory 104 for storing control software according to which the vehicle control device 102 operates, and data processed by the processor 103.

For example, the stored control software (computer program) has instructions that, when executed by the processor, cause the processor 103 to implement one or a plurality of neural networks 107.

The data stored in the memory 104 may, for example, include image data captured by one or a plurality of cameras 105. For example, the one or a plurality of cameras 105 may take one or a plurality of grayscale photographs or color photographs of the surroundings of the vehicle 101.

Based on the image data, the vehicle control device 102 can determine whether and which objects, e.g. fixed objects such as traffic signs or road markings or moving objects such as pedestrians, animals and other vehicles are present in the surroundings of the vehicle 101, i.e. perform object detection.

The vehicle 101 can then be controlled by the vehicle control device 102 according to the results of the object detection. For example, the vehicle control device 102 can control an actuator 106 (e.g., a brake) in order to control the speed of the vehicle, e.g., to brake the vehicle.

However, one or a plurality of sensors 108 other than an optical camera 105 (or even a plurality of cameras 105) may also be provided. Examples include radar sensors, LiDAR sensors, ultrasonic sensors and thermal imaging cameras.

These sensors (including cameras) have different advantages, and these advantages should typically be used in a suitable way to achieve a high level of reliability, e.g. object detection (including object recognition if necessary). For example, the lidar sensor provides a 3D point cloud with high resolution and is usually better than a radar sensor in terms of resolution. However, a radar sensor can penetrate water molecules without attenuation. It can therefore be used in all kinds of weather conditions. In addition, the Doppler effect of a radar sensor makes it possible to obtain an estimation of the radial speed of detected objects, which is an additional advantage of the radar sensor. An optical camera in turn offers (even) better resolution, which is helpful when segmenting and classifying objects.

The sensors (i.e. the sensor data they provide) can be fused at different levels. In early sensor fusion, the raw data from the different sensors is usually fused to create an object hypothesis for the surroundings. In late fusion, each sensor performs a separation prediction and then the results of the individual sensors are fused. In various applications, such as automated driving (AD), different levels of fusion are typically required for safety reasons in order to generate redundant predictions of the surroundings.

To prevent the poor measurement quality of a sensor from affecting the quality of the sensor fusion result, a multipath architecture can be used as described in reference 1.

FIG. 2 shows an example of a multi-path architecture for multimodal sensor fusion.

In this example, three sensors (e.g. a video sensor V, a radar sensor R and a lidar sensor L) provide sensor data.

For each of the sensors there is a respective path 201, 202, 203 and respective object hypotheses 204 are determined from the sensor data of the sensor. A feature selection 205 and feature combination is then performed in each case, which is based on the object hypotheses of the respective path and includes sensor data from the other sensors depending on the modality. This creates one branch 206 per modality. For example, the fourth branch from above, labeled V+RL, corresponds to a modality in which the object hypotheses were determined using the video data (V) and the feature selection and combination includes sensor data from the radar sensor (R) and the lidar sensor (L).

For each of the branches 206, for example, a classification and regression (e.g. to determine the bounding box of an object and its classification) 207 is then performed. The results of the classifications and regressions 207 from the branches 206 can then be combined in 208, e.g. object-based fusion. The result can also be selected in a simple manner from one of the branches 206.

Regardless of whether the results from the branches 206 are simply selected or combined in a more complicated way, it is desirable to achieve as far as possible, the exclusion of, or at least give low weight to, a result from one of the branches 206 that has a low accuracy due to a poor measurement quality of one of the sensors (e.g. because it is raining) from the determination of the final result (i.e. the result of 208).

Therefore, according to various embodiments, an approach for determining a respective confidence of a plurality of modalities (i.e., a confidence information for the result for the respective modality, i.e., from the respective branch 206) is provided.

This approach can be applied not only to a multipath (fusion) architecture as shown in FIG. 2, but to any object detection system or object tracking system that has redundant paths (or branches or paths) where different sensors contribute to the paths.

In particular, according to various embodiments, a permutation-invariant machine learning (ML) based estimation of confidences using a distance metric between the modalities (i.e. their results) is provided, i.e. an approach that takes into account the dependencies between the modalities. The distances between two modalities, e.g. between the bounding boxes for an object, which distances are determined for the modalities, for example the Mahalbonis distance is used.

According to various embodiments, the confidence of a modality is a value (e.g. between 0 and 1) indicating the distance of the position estimation (e.g. bounding box) from a modality to the correct position of the object.

According to the following exemplary embodiment, a scene (e.g. the surroundings of a vehicle) is divided into areas and it is assumed that the confidence of a modality is the same for all objects in the area. Accordingly, the object detection results of all objects in the area are included in the following exemplary embodiment.

FIG. 3 illustrates the determination of confidence information for modalities according to one embodiment.

It is assumed that an object detection result is provided for each of a plurality of modalities 301, e.g. position, dimension, class membership (e.g. as soft value), orientation and in particular a respective bounding box 302 for (in this example) each of a plurality of objects (from an area of a scene).

An input matrix 303 for a neural network 304 is formed from the bounding boxes 302.

Each row of the input matrix 303 is assigned to one of the objects. For this object, the line for each pair of modalities 301 contains the distance (e.g. Mahalbonis distance) between the bounding boxes that were determined for the object for the two modalities from the pair. If no position could be estimated for a modality, for example, a maximum value is used as the distance (to the estimation of other modalities).

With a number of m modalities, this results in a vector of n2=m*(m−1)/2 entries for each object.

If n1 is the number of objects in the area (which can be variable), the input matrix 303 therefore contains at least one matrix of size n1×n2. However, the input matrix 303 may contain further entries for each object, such as the positions of the bounding boxes estimated for the modalities for the respective object, the sizes of the bounding boxes estimated for the modalities, the classes of the objects predicted for the modalities, the mean of the estimated positions of the object across the modalities and the variance of the estimated positions of the object across the modalities, etc.

The neural network 304 is trained such that it provides an output 305 from the input matrix 303 which contains a confidence for each modality (or the result determined for the modality, e.g. the position prediction), i.e. a vector

(C_{mod_1},C_{mod_2}, . . . ,C_{mod_n})

To train the neural network, a ground truth vector (i.e. target-output vector)

(C_{mod_1}_{_{fin}},C_{mod_2}_{_{fin}}, . . . ,C_{mod_n_fin})
is generated for a training data element (with known object positions).

The entry C_{mod_i}_{_{fin}} of the ground truth vector for the i-th modality results from the distance between the position estimation for the modality and the actual object position, averaged over the objects.

FIG. 4 illustrates the distances between position estimations of two modalities and the distances to the true object position for the ground truth.

A first bounding box 401 is the result of an object detection for a first modality. A second bounding box 402 is the result of an object detection for a second modality. A third bounding box 403 corresponds to the correct object position.

The distance dm1_m2 between the two bounding boxes 402, 403 for the modalities is used as the entry in the input matrix 303 for the object (i.e. the respective row) and the pair of modalities (i.e. the respective column).

The following is used as the ground truth contribution for this object (these are averaged over all objects) for both i-th modalities

$${C}_{{mod\_i}_{fin}} = {e}^{- γ {d}_{mi\_GT}}$$

(wherein the exponential function can be averaged over the objects before or after application, i.e. it can C_{mod_i}_{_{fin}} be averaged over all objects or the distances can be averaged).

The following is equivalent

$${d}_{mi\_GT} = - \frac{1}{γ} ln ( {C}_{{mod\_i}_{fin}} )$$

wherein d_{mi_GT}, in the example of FIG. 4, is the distance dm1_GT between the bounding box 401 estimated for the first modality and the correct bounding box 403 or the distance dm2_GT between the bounding box 402 estimated for the second modality and the correct bounding box 403.

The above use of the exponential function provides a high confidence for low distances and a low confidence for high distances. A high distance corresponds to a low confidence, since with a high distance (i.e. a large error in the estimation for the modality) the modality should not be trusted very much. The confidence C_{mod_i}_{_{fin}} value is in the range [0, 1].

As mentioned above, the above example determines the confidence per area of a scene and assumes that the confidence is the same for all objects in the area. Alternatively, the confidence can also be determined for an entire scene or just for individual objects. Since the accuracy of each sensor for each object depends on the distance of the object from the sensor, and some objects in a scene may be occluded to a sensor while others are not, determining a common confidence for all objects in the scene may not provide a good estimation. The highest accuracy can be achieved with one confidence per individual object, but a common confidence (e.g. for objects in an area) allows independence from object tracking.

The estimation of the confidences (C_{mod_1}, C_{mod_2}, . . . , C_{mod_n}) should be independent of a permutation of the rows of the input matrix 303, as this merely corresponds to a renumbering of the objects. In contrast to a column permutation, the estimation should not be invariant, since the columns correspond to different attributes or pairs of modalities.

In order to achieve permutation invariance of the neural network 304 with regard to the rows (and thus equal treatment of the objects), a function such as minimum, maximum, multiplication, addition etc. can be inserted into the neural network via the rows in the column direction for each column. Alternatively, the same weights can be used in the neural network to process different rows.

According to one embodiment, a max-pooling layer is used. For example, the neural network 304 contains a 1D convolution layer that performs a 1D convolution for each column over the row entries of the column and then performs a max-pooling over the obtained (column) vector.

In summary, according to various embodiments, a method as shown in FIG. 5 is provided.

FIG. 5 shows a flowchart 500 illustrating a method for controlling a robot device according to one embodiment.

In 501, each sensor of a plurality of sensors receives a respective sensor data set from the sensor.

In 502, for each object of a set of objects containing at least one object, for each of a plurality of different combinations of the sensor data sets, a position prediction for the object is determined using sensor data fusion of the sensor data sets according to the combination of the sensor data sets.

In 503, for each object of the set of objects, for each pair of a plurality of pairs of the combinations, a distance between the position predictions determined for the object according to the combinations of the pair is determined.

In 504, the determined distances are fed to a neural network that is trained to determine confidence information for the position predictions from distances between position predictions for the pairs of combinations.

In 505, the robot device is controlled using one or a plurality of the position predictions taking into account the confidence information.

Each combination corresponds to a sensor fusion modality, i.e. a specific combination of sensors contributing to a respective branch of a sensor fusion system with multipath architecture as shown in FIG. 2. The sensor fusion system provides estimations (results) for each modality such as positions of objects, dimensions of objects, orientations of objects, class affiliations of objects (e.g. in the form of soft values) etc.

The method of FIG. 5 may be performed by one or a plurality of computers comprising one or a plurality of data processing units. The term “data processing unit” can be understood to mean any type of entity that enables the processing of data or signals. The data or signals can, for example, be processed according to at least one (i.e. one or more than one) specific function performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the respective functions described in more detail here can also be understood as a data processing unit or logic circuit array. One or a plurality of the method steps described in detail here can be carried out (e.g. implemented) by a data processing unit by means of one or a plurality of specific functions performed by the data processing unit.

In the above detailed exemplary embodiment, an application for autonomous driving is described, but the above described approach can also be used for other applications where sensor fusion is performed, and it is also not limited to the above mentioned sensors (i.e. sensor types).

In general, the approach shown in FIG. 5 is used to generate a control signal for a robot device. The term “robot device” can be understood as referring to any technical system (with a mechanical part whose movement is controlled), such as a computer-controlled machine, a vehicle, a household appliance, a power tool, a manufacturing machine, a personal assistant or an access control system.

Various embodiments may receive and utilize sensor signals from various sensors such as video, radar, LiDAR, ultrasound, motion, thermal imaging, etc., for example to obtain sensor data regarding demonstrations or states of the system (robot and object or objects) and configurations and scenarios. The sensor data can be processed. This can comprise classifying the sensor data or performing a semantic segmentation of the sensor data, for example in order to detect the presence of objects (in the surroundings in which the sensor data were obtained). Embodiments can be used to train a machine learning system and to control a robot, for example by robot manipulators autonomously, in order to accomplish various manipulation tasks in various scenarios. In particular, embodiments are applicable to the control and monitoring of the performance of manipulation tasks, for example in assembly lines.

Although specific embodiments have been illustrated and described here, a person skilled in the art in the field will recognize that the specific embodiments shown and described may be exchanged for a variety of alternative and/or equivalent implementations without departing from the scope of protection of the present invention. This application is intended to cover any modifications or variations of the specific embodiments discussed here. It is therefore intended that the present invention be limited only by the claims and the equivalents thereof.

1. A method for controlling a robot device, comprising:
receiving, from each sensor of a plurality of sensors, a respective sensor data set from the sensor;
determining, for each object of a set of objects containing at least one object, for each of a plurality of different combinations of the sensor data sets, a position prediction for the object by way of sensor data fusion of the sensor data sets according to the combination of the sensor data sets;
determining, for each object of the set of objects, for each pair of a plurality of pairs of combinations, a distance between the position predictions determined for the object according to the combinations of the pair;
feeding the determined distances to a neural network trained to determine confidence information for the position predictions from distances between position predictions for the pairs of combinations; and
controlling the robot device using one or a plurality of the position predictions taking into account the confidence information.

2. The method according to claim 1, wherein the set of objects contains a plurality of objects.

3. The method according to claim 2, wherein the set of objects comprises objects in a predetermined sub-area of the surroundings of the robot device detected by the sensors.

4. The method according to claim 1, wherein the neural network receives as input for each pair of the plurality of pairs of combinations the distance between the position predictions determined for the object according to the combinations of the pair and one or a plurality of results of object detection using the sensor data sets, and is trained to determine the confidence information from the input.

5. The method according to claim 1, wherein the set of objects contains a plurality of objects and the neural network is set up to be invariant to a permutation of the objects.

6. The method according to claim 5, wherein the neural network comprises a pooling of processing results of different objects.

7. The method according to claim 1, wherein the neural network is set up to process input data for a variable number of objects, the input data containing for each of the objects the distances between position predictions for the pairs of combinations.

8. The method according to claim 1, further comprising training the neural network by supervised learning using training data elements, wherein:
each training data element comprises a training input element having, for each pair of the combinations, a distance between position predictions for one or a plurality of objects of known position and a training target output element, and
the training target output element comprises, for each of the combinations, a training target output for the confidence information given by, for each of the one or a plurality of objects, a distance between the position prediction for the object according to the combination and the known position of the object.

9. A robot control device set up to perform a method according to claim 1.

10. A computer program comprising instructions that, when executed by a processor, cause the processor to carry out a method according to claim 1.

11. A computer-readable medium which stores instructions that, when executed by a processor, cause the processor to carry out a method according to claim 1.
